(19) United States
(12) Patent Application Publication
(10) Pub. No.: US 2020/0103971 A1
(43) Pub. Date: Apr. 2, 2020

(54) Method And Apparatus For Providing Realistic Feedback During Contact With Virtual Object

(71) Applicant: Center of Human-Centered Interaction for Coexistence, Seoul (KR)

(72) Inventors: Yong Ho. LEE, Seoul (KR); Dong Myoung LEE, Seoul (KR); Mincheol KIM, Seoul (KR); Bum Jae YOU, Seoul (KR)

(21) Appl. No.: 16/397,495

(22) Filed: Apr. 29, 2019

(30) Foreign Application Priority Data
Sep. 28, 2018 (KR) 10-2018-0115695

(51) Int. Cl. G06F 3/01; G06K 9/00

(52) U.S. Cl. CPC G06F 3/016; G06K 9/00375; G06F 3/014

(57) ABSTRACT

Disclosed are a method and apparatus for providing realistic feedback during contact with a virtual object. The method includes forming a plurality of physics particles to be distributed and arranged in a virtual hand model, detecting whether a physics particle of the virtual hand model contacts the virtual object and, recognizing the position of the physics particle that contacts the virtual object and transmitting vibration to a finger corresponding to the position when determining that the physics particle of the virtual hand model contacts the virtual object, wherein an intensity of the vibration is determined depending on the number of the physics particles that contact the virtual object and a penetration depth when the physics particle and the virtual object contact each other.

### CROSS-REFERENCE TO RELATED APPLICATION

This application claims priority to and the benefit of Korean Patent Application No. 10-2018-0115695, filed on Sep. 28, 2018. The entire disclosure of the above application is incorporated herein by reference.

### TECHNICAL FIELD

The present disclosure relates to a method and apparatus for providing realistic feedback during contact with a virtual object.

### BACKGROUND

The statements in this section merely provide background information on the present disclosure and do not necessarily constitute the prior art.

Along with development of technologies, interest in virtual reality or augmented reality has increased. In virtual reality, all of an image, a surrounding background, and an object are configured and shown in the form of a virtual image, on the other hand, in augmented reality, an actual appearance in real world is mainly configured and shown and only additional information is virtually configured and shown. Both virtual reality and augmented reality need to make users feel as though they are interacting with a virtual object.

As such, in order to make users feel as though they are interacting with a virtual object, computer haptic technology, i.e., haptics for allowing the user to feel touch is very important. Haptics is the term from the Greek adjective “Haptesthai” meaning “to touch” and refers to technology for sensing vibration, motion sensation, force, and the like by a user while manipulating input devices of various game consoles or computers, such as a joystick, a mouse, a keyboard, or a touchscreen and transmitting very realistic information such as computer virtual experiences to the user.

An initial haptic interface device is configured in the form of a glove and transmits only motion information of a hand to a virtual environment rather than generating haptic information for a user. That is, an example of the initial haptic interface device is the Nintendo glove that is an interface device developed by Nintendo in 1989, and in this case, a user controls a virtual environment using the glove, updates 2D graphics information, and transmits the updated 2D graphics information to the user. However, this kind of glove is configured by excluding a haptic element that is one of important elements for recognition of an object of a virtual environment, and thus, it is difficult to maximize sense of immersion of users exposed to the virtual environment.

Then, along with recent development and research on haptics, haptic glove technology for transmitting tactile sensation to a user has been much developed, but it is not possible for a user to accurately estimate a depth via virtual object manipulation in a virtual reality and mixed reality space and there is no sensation based on physical contact different from a real world, and thus, it is difficult to reproduce reality.

### SUMMARY

In accordance with some embodiments of the present disclosure, the above and other aspects of this invention can be accomplished by the provision of a method of providing realistic feedback during contact with a virtual object, the method including forming a plurality of physics particles to be distributed and arranged in a virtual hand model, detecting whether a physics particle of the virtual hand model contacts the virtual object, and recognizing a position of the physics particle that contacts the virtual object and transmitting vibration to a finger corresponding to the position when determining that the physics particle of the virtual hand model contacts the virtual object, upon determining that the physics particle of the virtual hand model contacts the virtual object, wherein an intensity of the vibration is determined depending on the number of the physics particles that contact the virtual object and a penetration depth when the physics particle and the virtual object contact each other.

In accordance with some embodiments of the present disclosure, the above and other objects can be accomplished by the provision of an apparatus for providing realistic feedback during contact with a virtual object, the apparatus including an input unit configured to provide input information for formation, movement, or deformation of a virtual hand model, a controller configured to form and control the virtual hand model based on the input information from the input unit, and a vibration unit installed on at least one fingertip, wherein the controller includes a physics particle formation unit configured to form a plurality of physics particles to be distributed and arranged in the virtual hand model, a contact determination unit configured to determine whether a physics particle of the virtual hand model contacts the virtual object, and a vibration transmission unit configured to recognize a position of the physics particle that contacts the virtual object and to perform control to transmit vibration to the vibration unit installed on a finger corresponding to the position when the contact determination unit determines that the physics particle of the virtual hand model contacts the virtual object, wherein an intensity of the vibration is determined depending on the number of the physics particles that contact the virtual object and a penetration depth in case that the physics particle and the virtual object contact each other.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram showing the configuration of an apparatus for providing realistic feedback during contact with a virtual object;

FIG. 2 is a diagram showing entire mesh data of a virtual hand model deformed in real time;

FIG. 3 is a diagram showing formation of physics particles in a virtual hand model;

FIG. 4 is a diagram for explanation of a method of determining whether a physics particle and a virtual object contact each other, which is used in an embodiment of the present disclosure;

FIG. 5 is a diagram showing a skeletal structure of a hand;

FIG. 6 is a diagram showing an example in which a vibration actuator is installed on a fingertip, as the vibration unit according to an embodiment of the present disclosure;

FIG. 7 is a diagram for explanation of function y according to an embodiment of the present disclosure; and

FIG. 8 is a flowchart showing a procedure of providing realistic feedback during contact with a virtual object according to an embodiment of the present disclosure.

### DETAILED DESCRIPTION

Hereinafter, at least one embodiment of the present disclosure will be described in detail with reference to the accompanying drawings. In the following description, like reference numerals designate like elements although the elements are shown in different drawings. Further, in the following description of the at least one embodiment, a detailed description of known functions and configurations incorporated herein will be omitted for the purpose of clarity and for brevity.

Additionally, various terms such as first, second, A, B, (a), (b), etc. may be used herein to describe various elements of the present invention, these terms are only used to distinguish one element from another element and necessity, order, or sequence of corresponding elements are not limited by these terms. Throughout the specification, one of ordinary skill would understand terms “include”, “comprise”, and “have” to be interpreted by default as inclusive or open rather than exclusive or closed unless expressly defined to the contrary. Further, terms such as “unit”, “module”, etc. disclosed in the specification mean units for processing at least one function or operation, which may be implemented by hardware, software, or a combination thereof.

It is an aspect of the present disclosure to provide a method and apparatus for providing realistic feedback during contact with a virtual object, for determining contact between a virtual object and a physics particle applied to a virtual hand model through a physical engine and then adjusting vibration intensity and transmitting vibration to a vibration unit of a corresponding finger according to an interaction situation to reproduce reality.

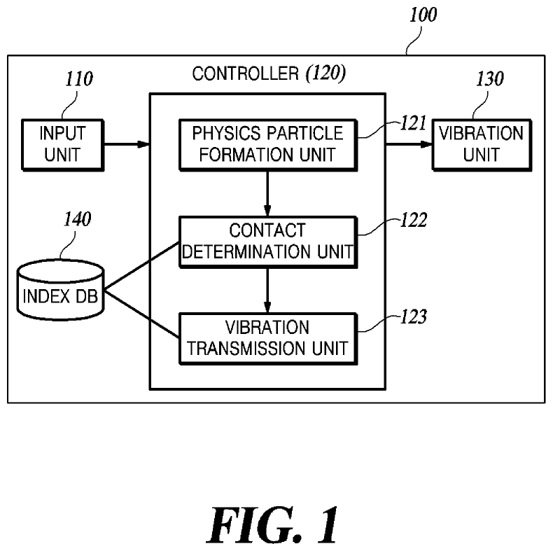

FIG. 1 is a block diagram showing the configuration of an apparatus for providing realistic feedback during contact with a virtual object.

As shown in FIG. 1, the apparatus 100 for providing realistic feedback during contact with a virtual object may include an input unit 110, a controller 120, a vibration unit 130, an index database (DB) 140, and so on, and here, the controller 120 may include a physics particle formation unit 121, a contact determination unit 122, a vibration transmission unit 123, and so on.

The input unit 110 according to an embodiment of the present disclosure may provide input information for formation, movement, or deformation of a virtual hand model to the controller 120. The input unit 110 may provide a physical quantity such as position, a shape, a size, a mass, a speed, a size and direction of applied force, a coefficient of friction, or elastic modulus as input information on the virtual hand model. In addition, the input unit 110 may also provide a variation of a physical quantity such as a change in a position, a change in a shape, or a change in a speed in order to move or deform the virtual hand model.

The input unit 110 according to an embodiment of the present disclosure may be a hand recognition device for recognizing a shape, a position, or the like of an actual hand. For example, the input unit 110 may be a glove with various sensors including a Leap motion sensor, an image sensor such as a camera, and an RGBD sensor, etc. or a separate device (e.g., a hand motion capture device) manufactured for measuring an exoskeleton, or may use a method of attaching a sensor directly to a hand. In addition, various sensors including an RGBD sensor and an image sensor such as a camera may be used as the input unit 110.

The input unit 110 according to an embodiment of the present disclosure may provide input information required to form the virtual hand model. That is, the input unit 110 may recognize a shape of an actual hand and may derive arrangement of bones in the actual hand based on the recognized shape. Accordingly, the input unit 110 may provide input information for forming bones of the virtual hand model. In addition, a coefficient of friction, a mass, or the like required to implement the virtual hand model may be provided as a preset value.

The input unit 110 according to an embodiment of the present disclosure may detect a change in the shape and position of the actual hand and may provide input information required to move or deform the virtual hand model based on the detected information. In this case, when a degree of freedom of connection between a bone and a joint of the virtual hand model, and a degree of freedom of the joint are preset, the input unit 110 may recognize only an angle at which each bone is disposed and a position of a joint in the actual hand to provide input information in a simpler form.

As described above, the input unit 110 according to an embodiment of the present disclosure may recognize motion in real space through a separate sensor to provide input information to the controller 120 or may just directly set a physical quantity such as a shape or a position to provide the input information to the controller 120.

The controller 120 according to an embodiment of the present disclosure may form and control the virtual hand model based on input information from the input unit 110.

The controller 120 according to an embodiment of the present disclosure may include the physics particle formation unit 121, the contact determination unit 122, the vibration transmission unit 123, and so on, and here, the physics particle formation unit 121 may form a plurality of physics particles in such a way that the plurality of physics particles are distributed and arranged in the virtual hand model.

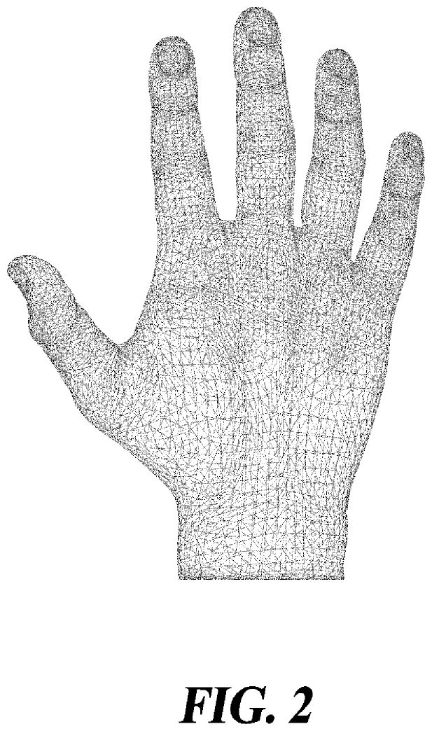

According to an embodiment of the present disclosure, a physical model of the virtual hand model may be generated using a physical engine in order to determine interaction between the virtual hand model and the virtual object. In this case, as shown in FIG. 2, when entire mesh data of the virtual hand model that is deformed in real time may be formed in a physics particle (a physical object), it is a problem in that it takes so long time in computation. That is, a mesh index per one hand is about 9000, and when positions of all mesh indexes that are changed in real time are applied to update an entire virtual hand physical model, the computation amount of the physical engine may be overloaded, and thus, it is not possible to ensure real-time.

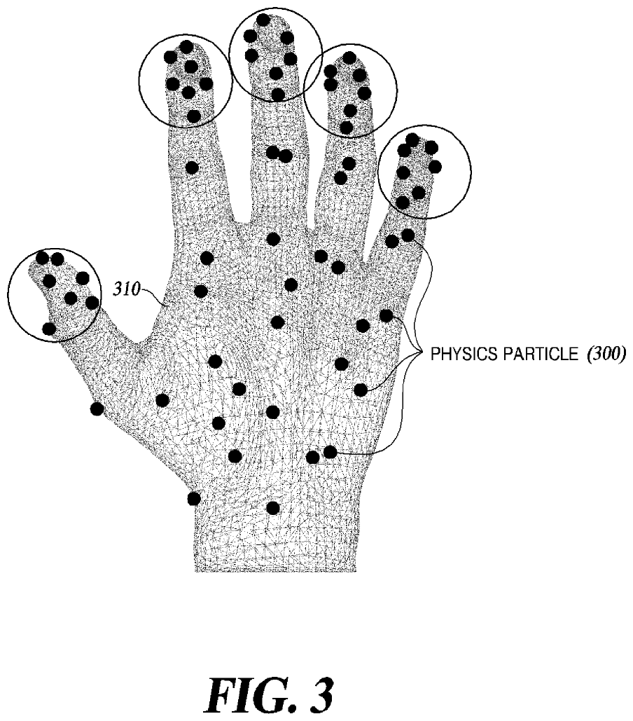

Accordingly, according to an embodiment of the present disclosure, as shown in FIG. 3, physics particles 300 may be generated only on mesh indexes on which contact mainly occurs when a user performs a hand motion, and physical interaction may be performed using the plurality of physics particles 300. According to an embodiment of the present disclosure, the physical attributes of the physics particle 300 may be defined as a kinematic object and various hand motions that occur in a real world may be appropriately implemented.

According to an embodiment of the present disclosure, the plurality of physics particles 300 may be particles with a small size and a random shape. According to an embodiment of the present disclosure, the physics particles 300 may be densely distributed on the last joint of a finger, which is a mesh index on which contact mainly occurs during a hand motion, and may be uniformly distributed on an entire area of a palm, and thus, even if a smaller number of particles is used rather than entire mesh data, a physical interaction result of a similar level to a method of using the entire mesh data may be obtained. According to an embodiment of the present disclosure, algorithms for various operations may be calculated using contact (collision) information between each physics particle 300 and a virtual object, and in this case, an appropriate number of the physics particles 300 may be distributed to prevent reduction in a computation speed of the physical engine due to an excessive number of particles while smoothing computation of such an operation algorithm with a sufficient number of particles. The appropriate number of the physics particles 300 may be derived through an experiment, and for example, about 130 of total physics particles 300 may be distributed and arranged on both hands.

The plurality of physics particles 300 may have various shapes, but preferably have a spherical shape with a unit size for simplifying computation. The plurality of physics particles 300 may have various physical quantities. The physical quantities may include positions at which the plurality of physics particles 300 are arranged to correspond to predetermined finger bones of a virtual hand model 310. Further, the physical quantities may include respective magnitudes and directions of force applied to the plurality of physics particles 300. The plurality of physics particles 300 may further have a physical quantity such as a coefficient of friction or an elastic modulus.

The contact determination unit 122 according to an embodiment of the present disclosure may determine whether the physics particle 300 of the virtual hand model contacts the virtual object. According to an embodiment of the present disclosure, as a method of determining whether the physics particle 300 and the virtual object contact each other, an axis-aligned bounding box (AABB) collision detection method may be used.

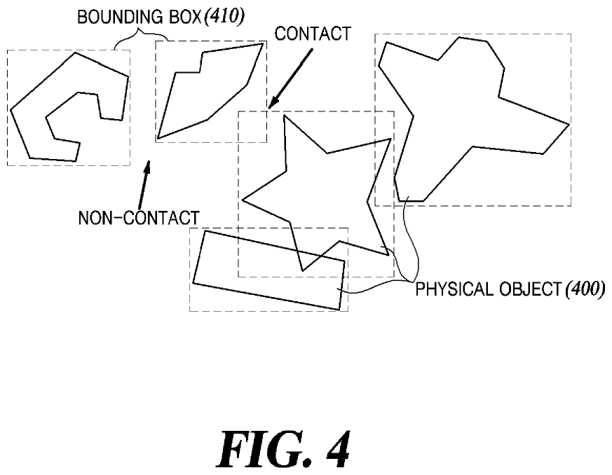

FIG. 4 is a diagram for explanation of a method of determining whether the physics particle 300 and a virtual object contact each other, which is used in an embodiment of the present disclosure.

As shown in FIG. 4, an AABB collision detection method may include covering all physical objects 400 with bounding boxes 410 that are aligned in the same axis direction, and checking whether respective bounding boxes corresponding to the physical objects 400 overlap each other in real time to determine whether the physical objects 400 contact (collide with) each other. Accordingly, the contact determination unit 122 according to an embodiment of the present disclosure may check a bounding box of the physics particle 300 disposed in the virtual hand model 310 and a bounding box of a virtual object, which interacts therewith, in real time and may detect whether the physics particle 300 and the virtual object contact (collide with) each other by determining whether bounding boxes of the physics particle 300 and the virtual object overlap each other.

Although, in the embodiment shown in FIG. 4, an AABB collision detection method has been described as a method of determining whether the physics particle 300 and the virtual object contact each other, the present disclosure is not limited thereto. For example, different from the aforementioned AABB collision detection method, various known collision detection methods such as an object oriented bounding box (OBB) collision detection method of changing directions of the bounding box 410 depending on a state of an object rather than fixing the bounding boxes 410 in the same axis direction, a sphere collision detection method of covering the physical object 400 with a sphere instead of the bounding box 410 and determining whether the spheres contact (collide with) each other, and a convex hull collision detection method of covering the physical object 400 with a convex hull instead of the bounding box 410 and determining whether the convex hulls contact (collide with) each other may be used. That is, any known collision detection method may be used according to an embodiment of the present disclosure as long as whether the physics particle 300 and the virtual object contact each other is determined.

When the contact determination unit 122 determines that the physics particle 300 of the virtual hand model contacts the virtual object, the vibration transmission unit 123 according to an embodiment of the present disclosure may recognize a position of the physics particle 300 that contacts the virtual object and may perform control to transmit vibration to the vibration unit 130 installed on a finger corresponding to the recognized position.

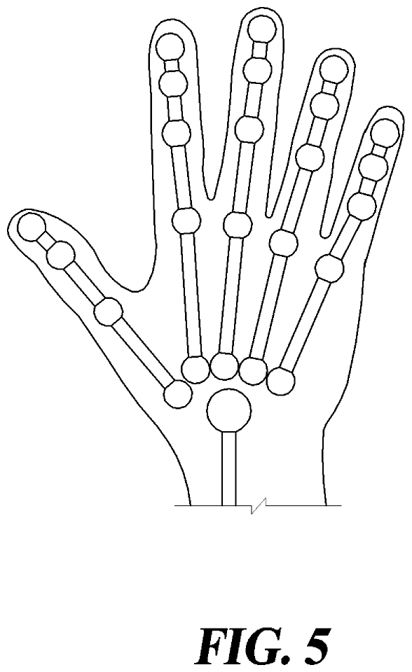

That is, as shown in FIG. 5, realistic feedback may be provided using a method of applying vibration to a corresponding finger based on a skeletal structure when the physics particle 300 adjacent to each finger bone contacts the virtual object. According to an embodiment of the present disclosure, the apparatus 100 may include the index DB 140 containing index information of a bone associated with a position of the physics particle 300 generated by the physics particle formation unit 121.

Table 1 below shows an example of index information stored in the index DB 140 according to an embodiment of the present disclosure.

TABLE 1

| Physics | | |
|---|---|---|
| particle number | Hand mesh index | Bone index |
| 1 | 1289 | 3 (LEFT_THUMB_DISTAL) |
| . . . | . . . | . . . |
| 10 | 3775 | 6 (LEFT_INDEX_DISTAL) |
| 11 | 4009 | 6 (LEFT_INDEX_DISTAL) |
| . . . | . . . | . . . |
| 130 | 9562 | 32 (RIGHT_PALM) |

That is, when the contact determination unit 122 determines that the physics particle 300 with a physics particle number #10 contacts the virtual object, the vibration transmission unit 123 may control the vibration unit 130 to apply vibration to a left index finger with reference to the index DB 140.

In other words, when the plurality of physics particles 300 that contact the virtual object are detected through the contact detection result of the contact determination unit 122, a finger corresponding thereto may be identified, and then, vibration may be transmitted to the vibration unit 130 corresponding to a finger determined to contact the virtual object. For example, when only the index finger contacts the virtual object, vibration may be transmitted only to the vibration unit 130 corresponding to the index finger, and when all five fingers contact the virtual object, vibration may be transmitted to the vibration units 130 corresponding to all five fingers.

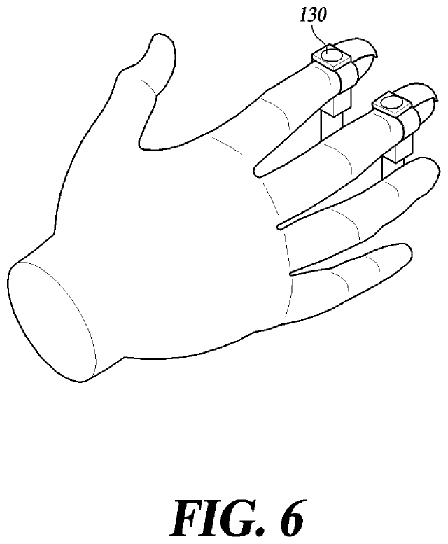

According to the aforementioned embodiment of the present disclosure, the apparatus 100 may include the vibration unit 130 installed on at least one fingertip. The vibration unit 130 according to an embodiment of the present disclosure may be a vibration actuator, a micro servomotor, a small vibrator, or a vibration motor, etc. FIG. 6 is a diagram showing an example in which a vibration actuator is installed on a fingertip, as the vibration unit 130 according to an embodiment of the present disclosure.

According to an embodiment of the present disclosure, intensity of vibration transmitted to the vibration unit 130 may be transmitted depending on the cases to provide more realistic feedback. Here, intensity of vibration may be determined according to the number of the physics particles 300 that contact the virtual object and a penetration depth when the physics particle 300 and the virtual object contact each other.

First, the number N(t) of the physics particles 300 that contacts the virtual object at time t may refer to an area of a hand portion that contacts the virtual object. Here, a parameter to which the number of the physics particles 300 that contact the virtual object at time t is applied in order to calculate the intensity of vibration may be Vn(t), which is represented according to an equation below.

$${V}_{n} ( τ ) = γ ( N ( t ) , {τ}_{count} ) \\ γ ( ρ , τ ) = exp ( - \frac{τ}{ρ} ) \qquad [ Equation 1 ]$$

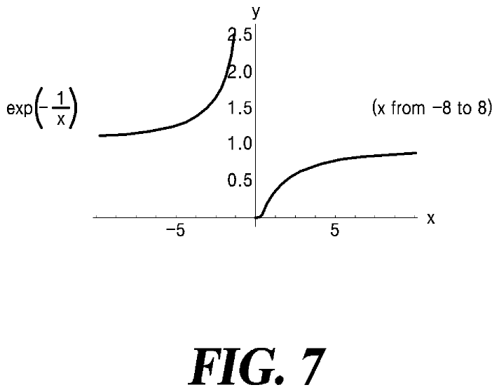

Here, function γ may be a function of unconditionally normalizing a result value to 0 to 1 with respect to input ρ. As shown in FIG. 7, an Output (y) may not exceed a maximum of 1 and may be infinitely close to 1 with respect to a certain Input (x). According to an embodiment of the present disclosure, ρ is a positive number, and thus, a minimum output may be 0. Here, as shown in a graph of FIG. 7, when an actual value of Input (x) exceeds about 5, Output (y) may be close to 1. Accordingly, τ of Equation 1 is a constant for alleviation for receiving input of a wider range.

That is, Vn(t) of Equation 1 may be a parameter for normalizing a result value with a value between 0 and 1 with respect to the number (N(t)) of the physics particles 300 that contact a virtual object at a time t and applying the normalization result to determination of intensity of vibration. As a result, as more physics particles 300 contact the virtual object, a value of Vn(t) may be close to 1.

Then, a penetration depth in case that the physics particle 300 and the virtual object contact each other refers to a level how much the physics particles 300 of a hand are inside the virtual object in the physical engine, that is, intensity by which a user presses the virtual object. Here, Vp(t) may refer to a parameter to which the penetration depth of the physics particle 300 that contact the virtual object each other at a time t is applied in order to calculate the intensity of vibration, which is represented according to an equation below.

Vₚ(t)=γ(P(t), τₚₑₙₑₜᵣₐₜᵢₒₙ)

P(t)=Σᵢ₌₁^{N(t)}pᵢ(t) [Equation 2]

Here, pᵢ(t) refers to a penetration depth of an i^{th} physics particle 300 that contacts at a time t, and accordingly, P(t) refers to the sum of penetration depths of the physics particles 300 at a time t. That is, Vp(t) of Equation 2 may be a parameter for a result value with a value between 0 and 1 with respect to the sum of the penetration depths P(t) to determine the intensity of vibration. As a result, as the sum of the penetration depths in case that the physics particles 300 and the virtual object contact each other increases, that is, the harder a user presses the virtual object, the closer a value of Vp(t) may become to 1.

Intensity of vibration to be transmitted to each finger may be calculated by using the aforementioned parameters Vn(t) and Vp(t) according to an equation below.

V(t)=α·Vₙ(t)+(1−α)·Vₚ(t) [Equation 3]

Here, V(t) may be a value between 0 and 1 as intensity of vibration transmitted at a time t. In addition, a is a constant to be multiplied to make V(t) that is the sum of two parameters Vn(t) and Vp(t) having a value between 0 and 1, to a value between 0 and 1. This is frequently referred to as alpha blending, and here, a is a weight indicating that which parameter has a greater weight to determine intensity of vibration among the two parameters (Vn(t) and Vp(t)). That is, in Equation 3 above, as a is increased, a weight of a contact area Vn(t) is increased in the result value.

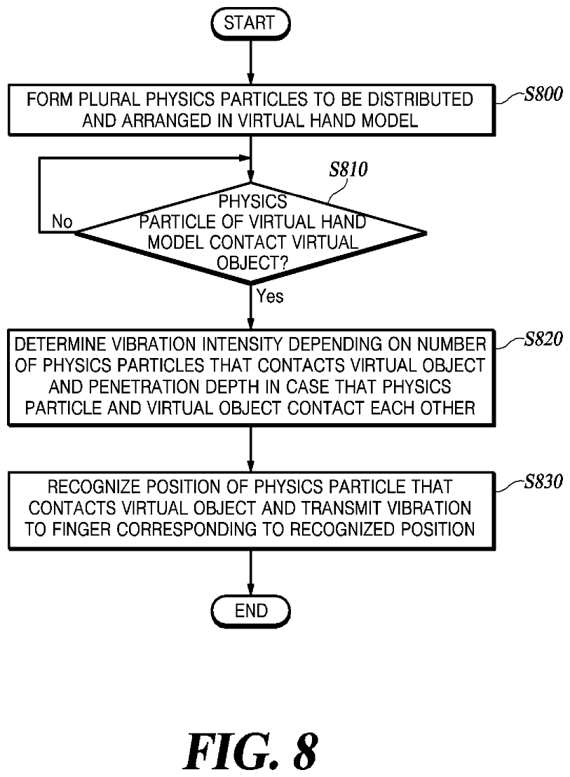

FIG. 8 is a flowchart showing a procedure of providing realistic feedback during contact with a virtual object according to an embodiment of the present disclosure.

First, the physics particle formation unit 121 according to an embodiment of the present disclosure may form the plurality of physics particles 300 to be distributed and arranged in the virtual hand model 310 (S800). As described above, according to an embodiment of the present disclosure, the physics particles 300 may be generated only on a mesh indexes on which contact mainly occurs when a user performs a hand motion, and physical interaction may be performed using the physics particles 300.

Then, the contact determination unit 122 according to an embodiment of the present disclosure may detect whether the physics particle 300 of the virtual hand model, which is generated by the physics particle formation unit 121, contacts the virtual object (S810). When the contact determination unit 122 determines that the physics particle 300 of the virtual hand model contacts the virtual object, vibration intensity may be determined depending on the number of physics particles that contact the virtual object and a penetration depth in case that the physics particle and the virtual object contact each other (S820).

The vibration transmission unit 123 according to an embodiment of the present disclosure may recognize a position of the physics particle 300 of the virtual hand model, which contacts the virtual object, using the index DB 140, and may transmit vibration to the vibration unit 130 of a finger corresponding to the recognized position (S830).

Steps S800 to S830 are described to be sequentially performed in FIG. 8 as a mere example for describing the technical idea of some embodiments, although one of ordinary skill in the pertinent art would appreciate that various modifications, additions and substitutions are possible by performing the sequences shown in FIG. 8 in a different order or at least one of steps S800 to S830 in parallel without departing from the idea and scope of the embodiments, and hence the examples shown in FIG. 8 are not limited to the chronological order.

The steps shown in FIG. 8 can be implemented as a computer program, and can be recorded on a non-transitory computer-readable medium. The computer-readable recording medium includes any type of recording device on which data that can be read by a computer system are recordable. Examples of the computer-readable recording medium include a magnetic storage medium (e.g., a floppy disk, a hard disk, a ROM, USB memory, etc.) and an optically readable medium (e.g., a CD-ROM, DVD, Blue-ray, etc.). Further, an example computer-readable recording medium has computer-readable codes that can be stored and executed in a distributed mode in computer systems connected via a network.

As described above, according to one aspect of the embodiments, it is possible reproduce reality by determining contact between a virtual object and a physics particle applied to a virtual hand model through a physical engine and then adjusting vibration intensity and transmitting vibration to a vibration unit of a corresponding finger according to an interaction situation.

Although exemplary embodiments of the present disclosure have been described for illustrative purposes, those skilled in the art will appreciate that various modifications, additions and substitutions are possible, without departing from the idea and scope of the claimed invention. Exemplary embodiments of the present disclosure have been described for the sake of brevity and clarity. Accordingly, one of ordinary skill would understand the scope of the disclosure is not limited by the explicitly described above embodiments but is inclusive of the claims and equivalents thereof.

What is claimed is:

1. A method of providing realistic feedback during contact with a virtual object, the method comprising:
forming a plurality of physics particles to be distributed and arranged in a virtual hand model;
detecting whether a physics particle of the virtual hand model contacts the virtual object; and
recognizing a position of the physics particle that contacts the virtual object and transmitting vibration to a finger corresponding to the position when determining that the physics particle of the virtual hand model contacts the virtual object,
wherein an intensity of the vibration is determined depending on the number of the physics particles that contact the virtual object and a penetration depth when the physics particle and the virtual object contact each other.

2. The method according to claim 1, wherein the plurality of physics particles are formed in the virtual hand model on a mesh index which contact mainly occurs when a user performs a hand motion.

3. The method according to claim 1, wherein the plurality of physics particles formed in the virtual hand model are uniformly distributed on a palm of the virtual hand model and densely distributed on a fingertip.

4. The method according to claim 1, wherein the plurality of physics particles formed in the virtual hand model has index information corresponding to a finger of the virtual hand model.

5. An apparatus for providing realistic feedback during contact with a virtual object, the apparatus comprising:
an input unit configured to provide input information for formation, movement, or deformation of a virtual hand model;
a controller configured to form and control the virtual hand model based on the input information from the input unit; and
a vibration unit installed on at least one fingertip,
wherein the controller includes:
a physics particle formation unit configured to form a plurality of physics particles to be distributed and arranged in the virtual hand model;
a contact determination unit configured to determine whether a physics particle of the virtual hand model contacts the virtual object; and
a vibration transmission unit configured to recognize a position of the physics particle that contacts the virtual object and to perform control to transmit vibration to the vibration unit installed on a finger corresponding to the position when the contact determination unit determines that the physics particle of the virtual hand model contacts the virtual object,
wherein an intensity of the vibration is determined depending on the number of the physics particles that contact the virtual object and a penetration depth when the physics particle and the virtual object contact each other.

6. The apparatus according to claim 5, wherein the vibration unit is a vibration actuator, a micro servomotor, a small vibrator, or a vibration motor.

7. The apparatus according to claim 5, wherein the plurality of physics particles are formed in the virtual hand model on a mesh index which contact mainly occurs when a user performs a hand motion.

8. The apparatus according to claim 5, wherein the plurality of physics particles formed in the virtual hand model are uniformly distributed on a palm of the virtual hand model and densely distributed on a fingertip.

9. The apparatus according to claim 5, further comprising an index database (DB) containing index information corresponding the plurality of physics particles formed on the virtual hand model to a finger of the virtual hand model.
